(19) United States
(12) Patent Application Publication
(10) Pub. No.: US 2006/0048203 A1
(43) Pub. Date: Mar. 2, 2006

(54) Method and device for the bi-directional transmission of electronic data in a television data cable network

(76) Inventor: Dirk Mensing, Biederitz (DE)

Correspondence Address: SUTHERLAND ASBILL & BRENNAN LLP, 999 PEACHTREE STREET, N.E., ATLANTA, GA, 30309, US

(21) Appl. No.: 10/529,073

(22) PCT Filed: Sep. 25, 2003
(86) PCT No.: PCT/DE03/03201

§ 371 Date: May 9, 2005

(30) Foreign Application Priority Data
Sep. 25, 2002 (DE) 10244928.7

(51) Int. Cl. H04N 7/173

(52) U.S. Cl. 725/123; 725/105; 725/126

(57) ABSTRACT

The invention relates to a method and an apparatus for bidirectional transmission of electronic data in a television data cable network having segments which each comprise two or more user interfaces, with each of the segments being connected via a cable connection to a feed point in the television data cable network. In the method, electronic downlink remote data is transmitted in a downlink radio-frequency band in an upper cut-off area of a transmission bandwidth of the cable connection, and electronic uplink remote data is transmitted in an uplink radio-frequency band in the upper cut-off area of the transmission bandwidth of the cable connection.

The invention relates to the field of bidirectional transmission of electronic data in a television data network based on cables.

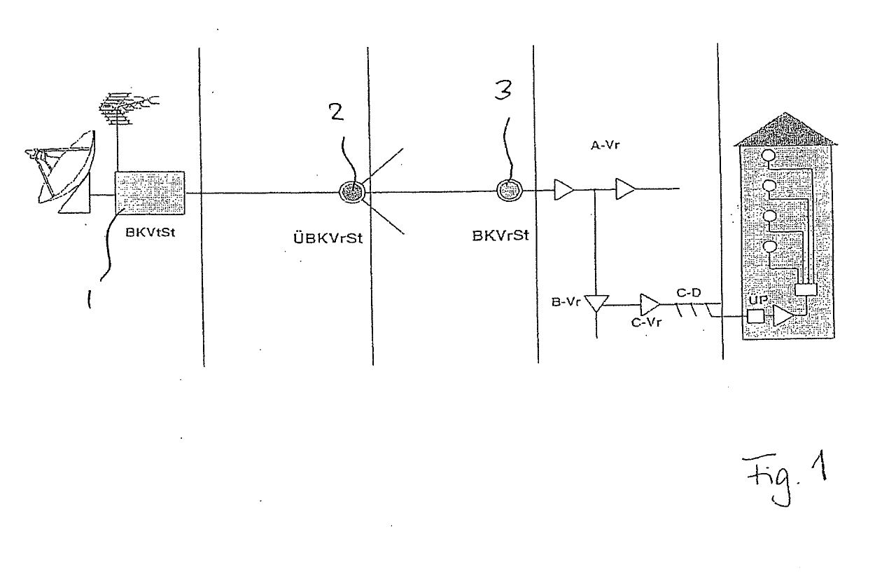

Cable networks based on coaxial cables have been upgraded with the aim of transporting television channels to end users and of distributing data signals within this network such that the maximum number of customers are reached. This relates to unidirectional distribution whose fundamental concept (an analog network) does not offer the capability to transport digital data bidirectionally. This bidirectional transport is required in order to make it possible to offer interactive services, such as the Internet. FIG. 1 shows a schematic illustration of the network levels in a conventional cable network. The cable network has a largely homogeneous structure. When planning a network for pure television distribution, factors such as the attenuation of the signals and interference in the coaxial cable are important. As is shown in FIG. 1, a broadband cable amplifier point 1 (BKVrSt) is followed by a higher-level broadband cable amplifier point 2 (ÜBKVrSt). The broadband cable amplifier point 1 and the higher-level broadband cable amplifier point 2 are part of a regional distribution network for supplying television programs. The local distribution network is followed by a connection network in which a user-end broadband cable amplifier point 3 (BBKVrSt) is arranged. The television data is then distributed in a local distribution network via A, B and C distributors (A, B and C-Vr). A lines are main lines which originate from a central network node in the cable network. B lines are lines which branch off from A lines and carry out a first subdistribution stage. C lines are once again branches of the B lines, via which line branching of the network is carried out.

The television data is fed via a handover point (ÜP) into a further network level, in which it is then distributed to the users. Even in relatively old networks, there are frequently glass-fiber connections for the distribution of television signals between the higher-lever broadband cable amplifier point 2 and the broadband cable amplifier point 3. The amplifier points are arranged downstream from the broadband cable amplifier point 3, at a maximum distance of 300 m.

Cable network operators are increasingly attempting to extend their range of services. This relates to services such as pay-TV, Video on Demand, “high-speed” Internet via the cable network and telephony. In order to make it possible to offer Internet data via the cable networks, the cable network must have a return-channel capability, which means that data must also be passed back in the opposite direction to the television signals. In this case, approximately 70% of the total investment costs for the technical conversion of the cable network are incurred in the area of the local distribution network and in the downstream further network level. The magnitude of the investment costs is dependent on how the upgrading of the networks is planned.

With regard to the upgrading of the cable networks, a distinction must be drawn between subject areas which are often combined under the common denominator of upgrading: (i) upgrading to 862 MHz and (ii) return-channel capability. Upgrading to 862 MHz means extending the frequencies from the conventional 450 MHz to 862 MHz in the cable network, thus providing more capacity in the networks for the services. In conjunction with Internet services, which require a channel for the downlink datastream (“Downstream”), there is often a deficit of free channels in the conventional 450 MHz networks. Upgrading to 862 MHz is frequently carried out in order to make it possible to offer a broader range of digital television programs. The configuration of the return-channel capability is a type of upgrading of the cable networks which allows data to be transported in the reverse direction, and thus in the opposite direction to the conventional television channels. This makes it possible, for example, to provide Internet services.

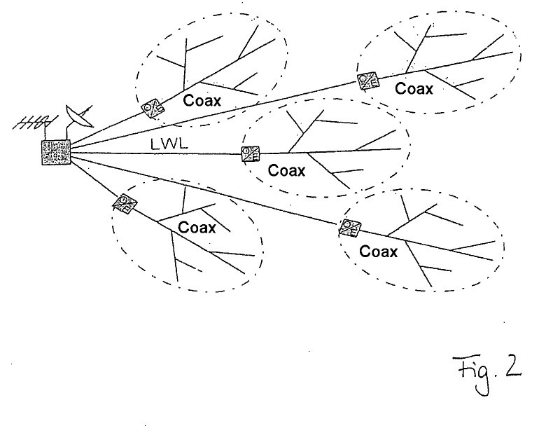

Currently, the upgrading of the cable networks requires relatively large amounts of investment since use is made of a so-called “Hybrid Fiber Coax” (HFC) structure, by means of which the use of glass-fiber and coaxial cables is combined in one network. In this case, glass-fiber cables are replacing the coaxial cables in the area of the local distribution network. The glass-fiber cables must first of all be laid for this purpose. FIG. 2 shows the principle of a cable network that has been upgraded using HFC technology. The coaxial cables (Coax) normally used in the cable network are combined with glass-fiber cables (optical waveguides). The use of glass-fiber cables in cable networks differs from the use of glass-fiber cables in telecommunications networks. Telecommunications networks transport information independently of the content of this data. Irrespective of whether this relates to Internet data or MPEG image data—transportation in a glass-fiber network is the same. This results in a high degree of standardization in the network. Television signals are passed on in a transparent form via the glass-fiber cables (in analog or digital form) via the glass fibers in the HFC network. These signals are transported in glass fibers to a fiber node. If it is also intended to offer Internet services, each node requires two glass-fiber connections; one for the downlink datastream and one for the return-channel. Since specific information, such as the channel allocation in the cable network, is already included in the signal, this does not relate to conventional data standards, as is the case in the Internet or in WAN networks. The signal is converted from the glass-fiber network to the coaxial cable network in the fiber nodes. In this case, the signal is no longer processed since it is already in a modulated form in the glass fiber. The expression a hub is also often used at this point, although this has a different function in a purely digital network.

During the conversion to copper (coaxial cable), the frequency range from 5-65 MHz or 5-45 MHz is used for the return-channel, depending on the network, and frequencies above 303 MHz are used for the downlink data connection. A CMTS (“Cable Modem Termination System”) which is used in this case has, in particular, the task of assigning the frequencies for the downlink datastream and the uplink datastream. In addition, CMTS provides the link to the wide area network and/or to the Internet service provider. Here, the signals are converted to a telecommunications standard, for transmission to the wide area network. The connection from the CMTS to a data network is provided by a conventional standard (STM, ATM, 100BaseT, etc.). The downlink datastream (downstream) for Internet use is transported in a free television channel to the customer modems.

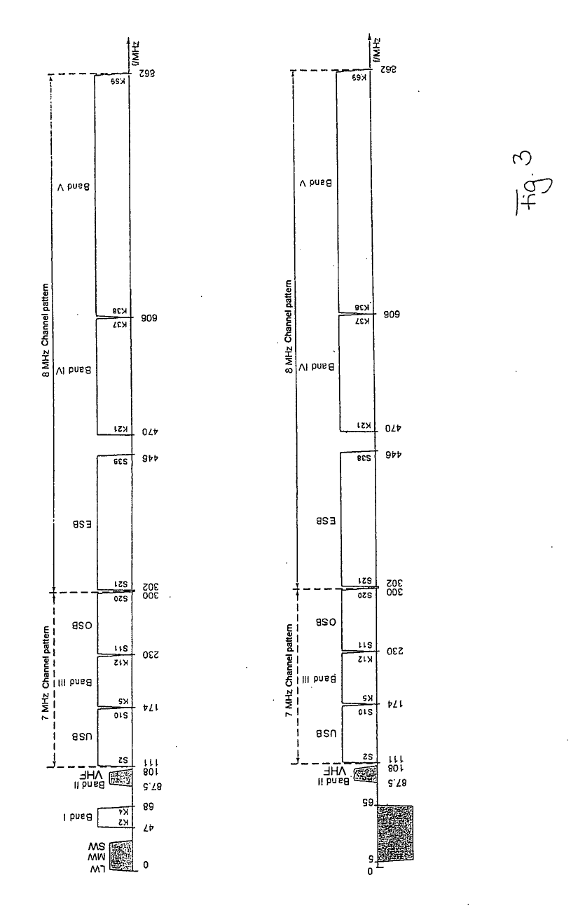

FIG. 3 shows, schematically, the use of the frequency band for a television data cable network as it was originally used (upper illustration in FIG. 3) and using HFC technology (lower illustration in FIG. 3), for comparison. For HFC technology, the return-channel 30 is operated in the frequency range from 5-65 MHz or 5-45 MHz. Owing to the high susceptibility to interference, the modulation method that is used is QPSK (QPSK—“Quadrature Phase Shift Keying”) up to a maximum of QAM 16 (QAM—“Quadrature Amplitude Modulation”) so that a capacity of 3 to 10 Mbit/s is available in the return-channel. The CMTS can serve a number of return-channels at the same time. This results in a concentration of return-channel data at the CMTS level.

Conventional cable networks have a channel allocation with a bandwidth of 8 MHz per channel, as standard. One analog program or 5-6 digital programs can be accommodated in one 8 MHz channel. If a channel is left free, that is to say it is not used by a television program, then up to 52 Mbit/s of modulated data can be transmitted in the downlink. This characteristic is used in order to supply the Internet data to the customer in the downlink direction (downstream) via the glass fibers and, later, via the coaxial cable. The assignment of the downlink datastream channel to a cable modem via which the customer is connected to the cable network, as well as the allocation to the cable modem on which frequencies from the uplink datastream can be sent, is a function of the CMTS.

The object of the invention is to provide an improved method and improved apparatus for bidirectional transmission of electronic data in a television data cable network, which allow implementation, which can be carried out with less complexity and thus more cost-effectively, of bidirectional transmission of electronic data for extended media services with a wider bandwidth in the television data cable network.

According to the invention, the object is achieved by a method as claimed in the independent claim 1, and by an apparatus as claimed in the independent claim 8.

The invention comprises the idea of forming a return-channel capability in a television data cable network by the formation of a backbone in an upper cut-off area of a transmission bandwidth of the cable connections of the television data cable network. Both a downlink datastream (downstream) and an uplink datastream (upstream) are provided via the backbone. The data which has been fed in via a feed point in the television data cable network is converted for transmission in the backbone. In order to emit the data to the user interfaces via which a user has connected the appliance used by him, for example a personal computer or a television, to the television data cable network, this data is then once again converted from the upper cut-off area of the transmission bandwidth. The data transfer between the user interface and the feed point likewise takes place in the opposite direction with the aid of at least double data conversion. This makes it possible for the user to still use his conventional cable modem via which the appliance used by him is connected to the television data cable network, even though the data is transmitted in a frequency range other than that normally used for data transfer.

This also results in the advantage that, in comparison to the known HFC technology, there is no need to replace the existing coaxial cables by glass-fiber cables, thus leading to considerable cost savings. The use of the upper cut-off area of the transmission bandwidth furthermore allows the provision of adequate bandwidth for high data transmission capacities.

Advantageous refinements of the invention are the subject matter of the dependent claims.

The invention will be explained in more detail in the following text using exemplary embodiments and with reference to a drawing, in which:

FIG. 1 shows a schematic illustration of a structure of a cable network according to the prior art;

FIG. 2 shows a schematic illustration of a cable network with a known HFC structure (HFC—“Hybrid Fiber Coax”) according to the prior art;

FIG. 3 shows, schematically, the use of the frequency band in a television data cable network according to the prior art in its original form, and using HFC technology, for comparison;

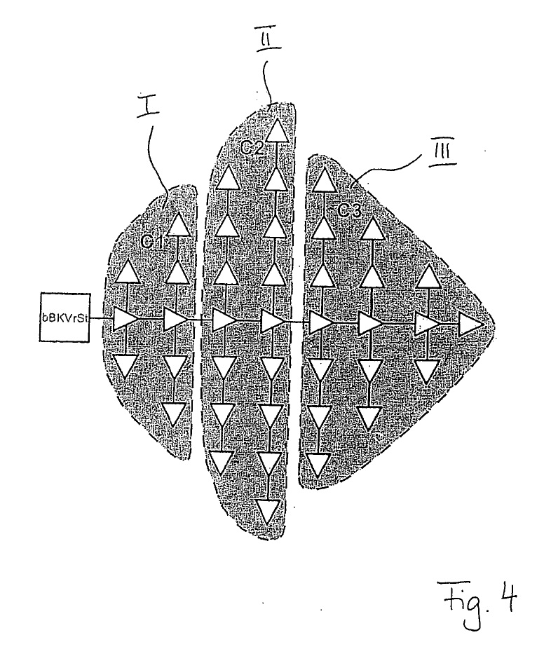

FIG. 4 shows a schematic illustration of subdivision of a television data cable network into segments;

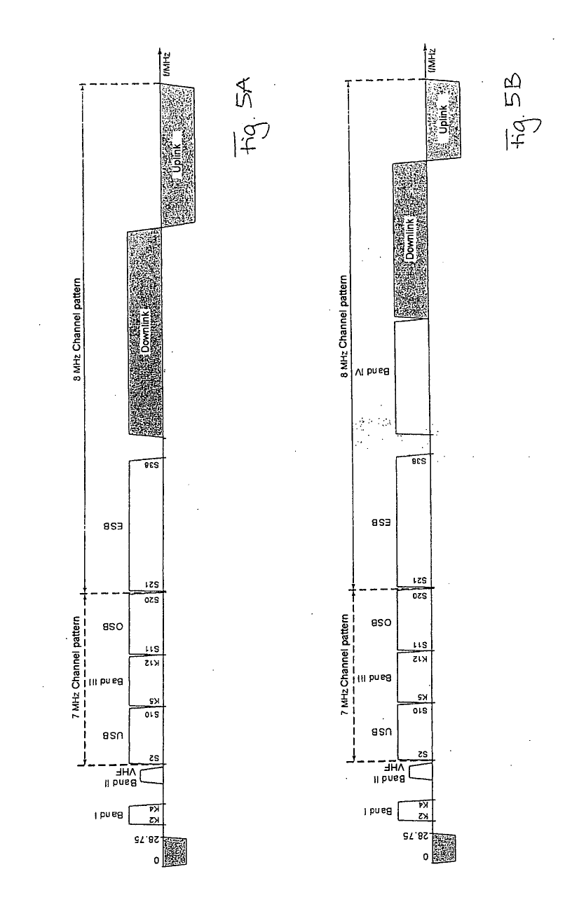

FIGS. 5A and 5B show, schematically, the use of the frequency band in a television data cable network for different embodiments, with an area for the downlink datastream and the uplink datastream in each case being formed in the upper cut-off area of the transmission bandwidth;

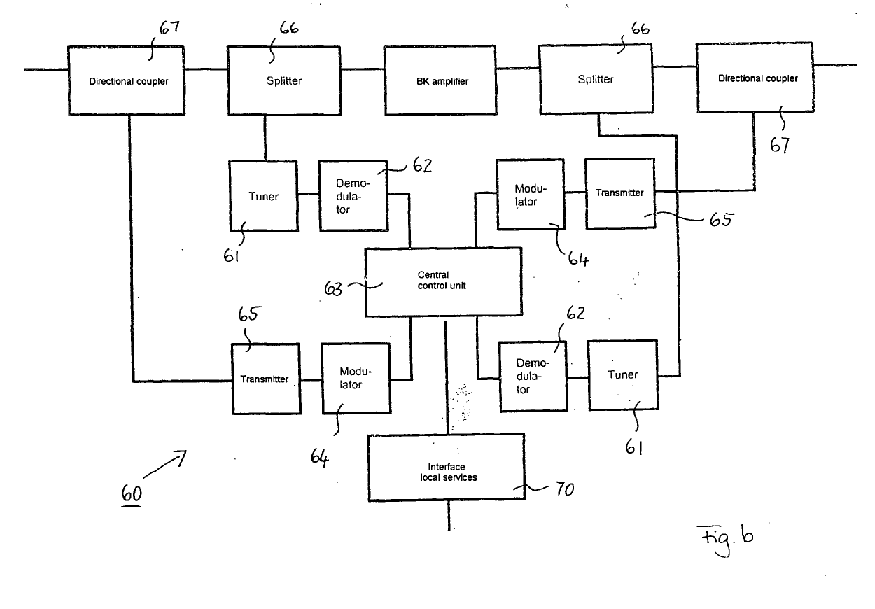

FIG. 6 shows a schematic block diagram of an apparatus for processing electronic data for bidirectional transmission of electronic data in a television data cable network with the frequency band being used as shown in FIG. 5A or 5B;

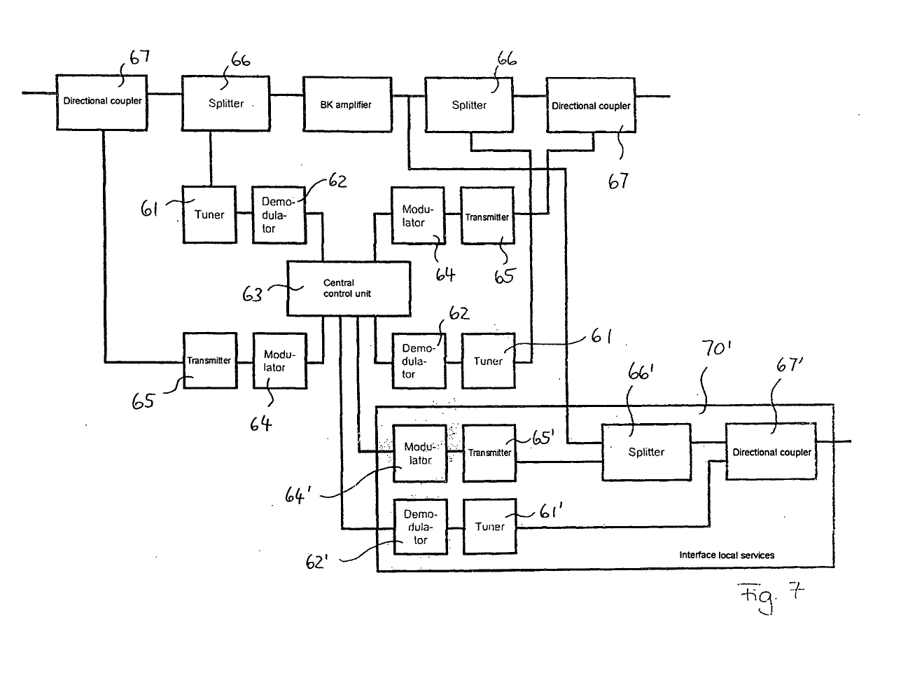

FIG. 7 shows a schematic block diagram of a further apparatus for processing electronic data for bidirectional transmission of electronic data as shown in FIG. 6, showing an interface for local services in detail;

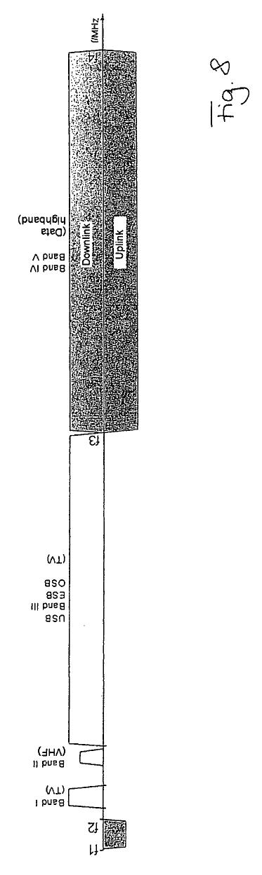

FIG. 8 shows a frequency plan;

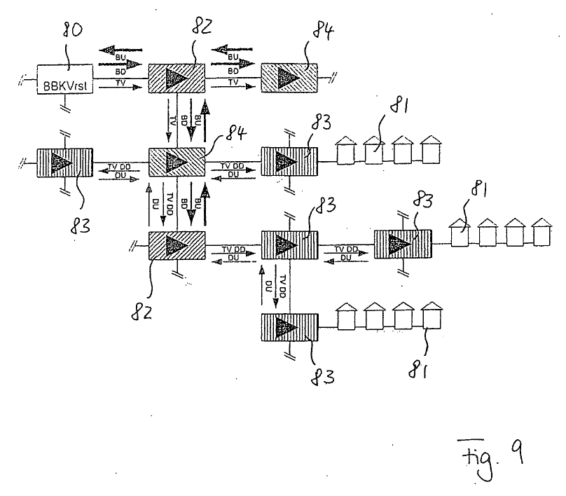

FIG. 9 shows a schematic illustration of a section from the segmented television data cable network shown in FIG. 4;

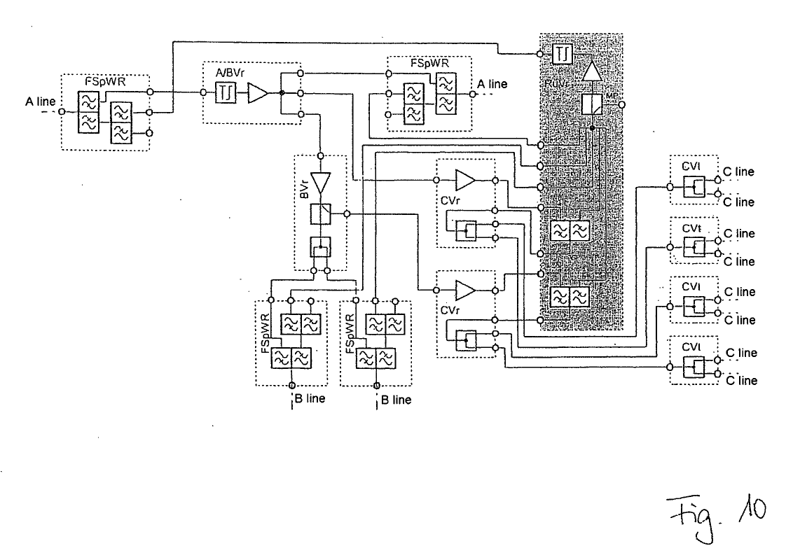

FIG. 10 shows a schematic illustration of an amplifier point in the section from the segmented television data cable network shown in FIG. 9;

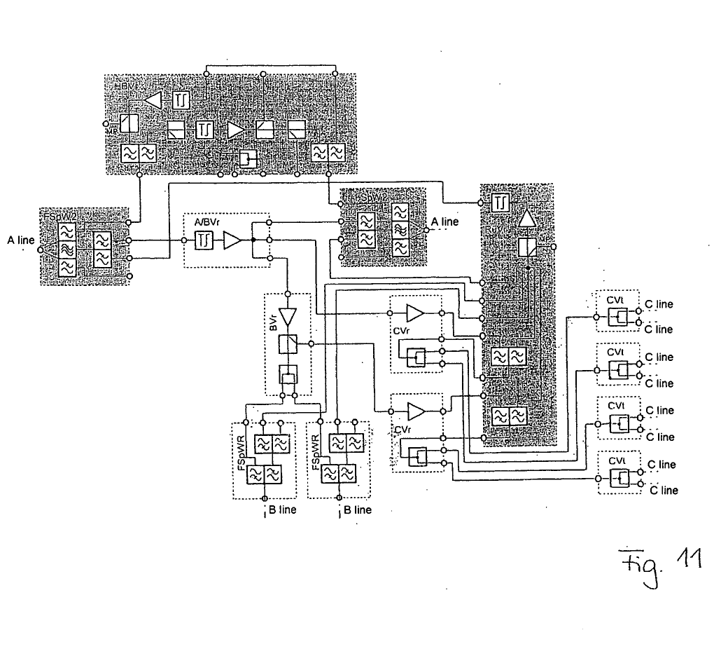

FIG. 11 shows a schematic illustration of a further amplifier point in the section from the segmented television data cable network shown in FIG. 9;

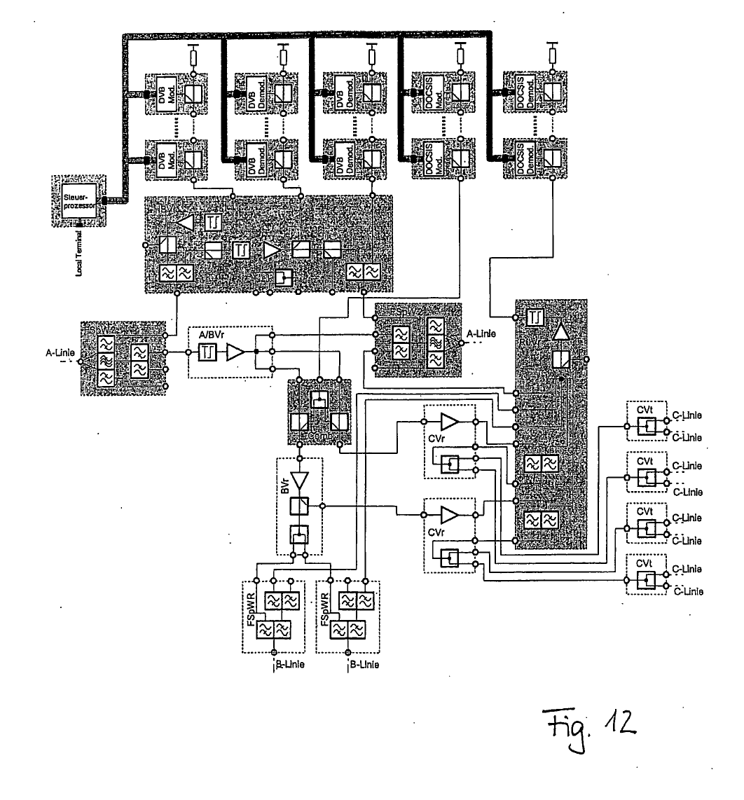

FIG. 12 shows a schematic illustration of another amplifier point in the section from the segmented television data cable network shown in FIG. 9; and

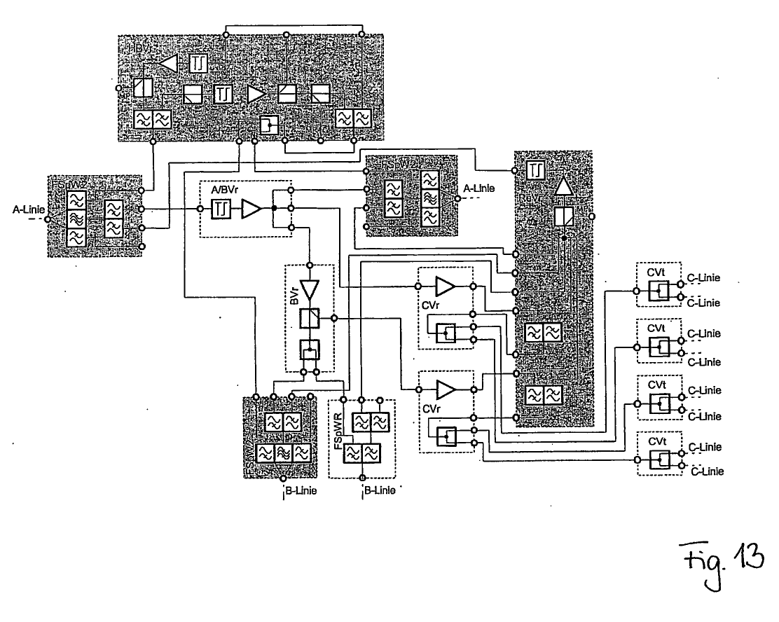

FIG. 13 shows a schematic illustration of a modified amplifier point for the further amplifier point in FIG. 11.

A method and an apparatus for bidirectional transmission of electronic data in a television data cable network will be described in the following text with reference to FIGS. 4 to 13. As can be seen from FIG. 4, the television data cable network is subdivided into a number of segments I, II and III. Each segment may, for example, have 250 to 500 user interfaces, which are normally allocated to a dwelling unit which is connected to the television data cable network. The segments I-III are in the form of DOCSIS segments (DOCSIS—“Data Over Cable Service Interface Specification”). This is a conventional standard for the transmission of digital data in television data cable networks. Data is transmitted within the segments I-III in accordance with the known (Euro)DOCSIS Standard. The downlink datastream (downstream) to the user interface is normally in the form of one or two channels with a width of 8 MHz. An uplink datastream (upstream) of television signals away from the user locations is carried out using a frequency range between 5 and 28.75 MHz.

In order to carry out a bidirectional data transfer for extended media services, in particular high-speed Internet data, in the transmission band of the cable network, a backbone is provided in the exemplary embodiment shown in FIGS. 5A and 5B, in an upper cut-off area of the transmission bandwidth of the television data cable network, which is also referred to in the following text as a highband, via which backbone the data for the extended media services is transmitted to the DOCSIS segments I-III. The backbone is provided in a frequency range above 470 MHz or 606 MHz (see FIGS. 5A and 5B). The backbone frequency bands are in this case adjacent to one another, with an adjacent embodiment also being present when the frequency bands (uplink, downlink) are separated in order to avoid technical problems, in particular mutual signal interference. In this case, by way of example, it is possible to provide transmission rates of up to 1 GBit/s in each direction.

A processing device 60, as is illustrated schematically in FIG. 6, is used as the interface for processing electronic data between the DOCSIS Standard and the backbone in the upper frequency range. Depending on the location within the segmented television data cable network, the processing device 60 is used for processing customer-specific data, in order to make it possible to carry out broadband transmissions in the backbone from a feed point to the user interfaces, or in the opposite direction. Data conversions between the DOCSIS Standard and the upper cut-off area, in which the backbone is formed, are required for this purpose.

The function of individual elements of the processing device 60 is shown in Table 1.

TABLE 1

| Ref | | | |
|---|---|---|---|
| Sym- | Desig- | | |
| bol | nation | Embodiment | Function |
| 61 | Tuner | Highband receiver, | Reception of highband |
| | | downlink/uplink | data from both directions |
| | | datastream | |
| 62 | Demodula- | DOCSIS receiver, | Demodulation of the |
| | tor | highband downlink | highband signals from |
| | | datastream receiver, | both directions |
| | | highband uplink | Demodulation of the |
| | | datastream receiver | DOCSIS signals from both |
| | | | directions |
| 63 | Central | Control processor | Conversion of the |
| | control | | highband data to DOCSIS, |
| | unit | | and vice versa |
| 64 | Modulator | DOCSIS transmitter, | Modulation of the |
| | | highband downlink | highband data for both |
| | | datastream | directions, modulation of |
| | | transmitter, | the DOCSIS data for both |
| | | highband uplink | directions |
| | | datastream | |
| | | transmitter | |
| 65 | Trans- | Highband amplifier, | Processing of the |
| | mitter | downlink and uplink | modulated signals to the |
| | | datastream | Coax transmission |
| | | | standard |
| 66, | Splitter, | Frequency splitter | Separation and combi- |
| 67 | directional | | nation of the fre- |
| | coupler | | quency ranges for |
| | | | remote feed, radio |
| | | | and television signals, |
| | | | highband downlink/ |
| | | | uplink datastream |

Some of the functional blocks of the processing device 60 may be combined and/or may be at least duplicated. For example, the directional coupler 67 and the splitter 66 may be combined and may, for example, be in the form of a multistage frequency splitter (FSpW). There may be two or more multistage frequency splitters on the output side carrying out, inter alia, the function of inputting and outputting of a remote feed voltage. For this frequency splitter: f1<f2<f3<f4<fₜₒₜ. fₜₒₜ is in the range from 0 Hz up to and including 2.4 GHz.

The functional groups comprising the tuner 61, the demodulator 62 and/or the modulator 64 and the transmitter 65 may be in the form of a common block. In any case, it should be mentioned that these functional blocks are generally at least duplicated. The central control unit 63 is associated with functions such as a multiplexer, a demultiplexer, access control for the media, bandwidth administration, billing functions, subscriber administration and management. The functionality of the functional elements 61′, 62′, 64′, 65′, 66′, 67′ is comparable to that of the functional elements 61, 62, 63, 64, 65 and 67. A B line branch 70′ can be defined as the interface 70 for local services. In order to illustrate this exemplary embodiment, FIG. 7 shows one possible configuration of the functional block 68. In a further embodiment (which is not illustrated), the modulator 64′ and the demodulator 62′ may be omitted.

The plan illustrated in FIG. 8 is used for the frequency allocation in a further exemplary embodiment. The DOCSIS uplink datastream (return path) is provided between f1 and f2, as standard. The downlink datastream is transmitted in a free television channel in the ESB (ESB=Extended Special channel Band), that is to say between f2 and f3. Depending on the requirement for the respective transmission rate, the downlink and uplink datastream can be provided in the frequency range from f3 to f4 (subdivided into 2 subareas in the frequency band).

FIG. 9 shows a schematic illustration of a section from the segmented television data cable network, in which both television data and further electronic data, such as Internet data, are transmitted between a feed point 80 and user interfaces 81. This is done using a downlink datastream (DD) and an uplink datastream (DU) in accordance with the DOCSIS Standard. According to the DOCSIS Standard, conventional television data (TVDD) is transmitted as well as local data in the downlink datastream (DD). Furthermore, electronic data is transmitted downstream (BD) and upstream (BU) via the backbone. A processing apparatus 82 is implemented at each of two points in the section illustrated in FIG. 9, and these processing apparatuses 82 correspond to the processing device 60 shown in FIG. 6. FIG. 12 shows one possible detailed embodiment of a processing device such as this as an amplifier point. Further amplifier points 83 and 84 will be explained in the following text, in conjunction with FIGS. 10 and 11, together with the respective functional description.

When electronic data is transmitted from the feed point 80 to the user interfaces 81 (downlink datastream), the required electronic data is fed in at the feed point 80 digitally in a frequency range above 470 or 606 MHz. The processing device 82 is used to demodulate, process and remodulate all of the transmitted data. For user interfaces which are associated with the processing device 82, the required data is transmitted in accordance with the DOCSIS Standard in an extended special channel band (ESB). For all of the other user interfaces, the required data is once again modulated in the upper cut-off area of the transmission band with the backbone, and is transmitted to the associated segments. Commercially available cable modems may be used at the user interfaces in order to demodulate the data, which is received in accordance with the DOCSIS Standard, for reproduction, for example by means of personal computers, telephones or the like.

For data transmission from the user interfaces 81 to the feed point 80 (downlink datastream), the data which is fed in by the user via the cable modem at the customer end is modulated into the frequency range between 5 MHz and 28.75 MHz. When the data that has been fed in in this way reaches the first processing device, further processing is carried out, which comprises demodulation and modulation in the upper frequency range with the backbone. This data is then transmitted to the feed point 80 via the backbone. Any desired modulation methods which allow data communication at high data rates are used for data transmission in the upper frequency range above 470 or 606 MHz. For example, channels with a bandwidth of 8 MHz are used in which between 38 Mbit/s and 52 Mbit/s can be transmitted per channel, depending on the characteristics of the cable in the television data cable network. The 64-QAM or 256-QAM (QAM—“Quadrature Amplitude Modulation”) modulation method, which is known from the DOCSIS Standard, is also used. Up to 2000 Mbit/s can be transmitted in all of the channels in the backbone. The subdivision of the bandwidth into a forward path and return path results in adequate data rates in this frequency range to supply, for example, a total of 5500 or 7500 users on one coaxial cable.

One or more communication processors is or are a major component of the processing device 60. These processors are used primarily to control a data bus, which represents the internal interface standard. External interfaces are also controlled, in addition to the data bus. These external interfaces can be plugged in and can thus be interchanged. The simplified illustration shown in FIG. 8 illustrates three interfaces:

(a) Radio-Frequency Interface to the Output Point

This interface is designed on the basis of components based on the DVB-C Standard (DVB—“Digital Video Broadcast”). Owing to the capability to transport data on the basis of the DVB Standard, both the uplink data and the downlink data to and from the processing device are fed back to the output point by means of this function. The amplifiers in the downlink datastream make the downlink datastream channels available to each A amplifier point. The assignment of downlink datastream channels to the DOCSIS modems is likewise carried out by the processing device 60. This results in optimum flexibility with regard to capacity assignment, since two or more DOCSIS segments can optionally use their own downlink datastream channel or a downlink datastream channel which is already being used by another segment. QAM 16 to QAM 256 may be used for modulation allowing a capacity of up to 52 Mbit/s per downlink datastream channel and 8 MHz channel bandwidth. The required backward amplifier for the upper frequency range is a sub-octave band amplifier whose cost is considerably less than that of the controlled downlink datastream amplifiers, which have to amplify the entire band from 5 to 862 MHz.
   b) (Euro)DOCSIS Interface to the Cable Modems
The DOCSIS interface allows the use of conventional cable modems. The electronic components which are required for DOCSIS are commercially available, for example from manufacturers such as Broadcom or Texas Instruments. In conventional HFC networks, the DOCSIS modems are managed by a function in the CMTS. In the exemplary embodiment, the management of the channels in the DOCSIS segments (see FIG. 4) and the monitoring via the MAC (MAC—“Medium Access”) and PHY (“Physical”) layer are carried out by the processing device. This procedure allows each segment to be integrated in the overall network architecture but to be operated as an autonomous unit, thus minimizing problems relating to the time response. For this reason, outputting to a telecommunications network is possible at any point at which a processing device is installed and an appropriate interface is available. Components for the DOCSIS interface can likewise be supplied by companies such as Broadcom or Texas Instruments.
   c) Output Interface to the Backbone in the Upper Cut-Off Area of the Transmission Bandwidth
The output interface to the backbone connects the coaxial network to a telecommunications infrastructure, such as that used by a network operator. There are a large number of standards for this output function, which can be retrofitted appropriately, as required. Provision is made, for example, for the 100BaseT and STM interfaces. This allows outputting both on copper and on an optical basis. Installation at the amplifier point.

The implementation of the described method also requires a number of frequency splitters at the amplifier point. The frequency band is subdivided by the frequency splitters into the two areas of downlink and uplink at the A level (47-700 MHz and 750-862 MHz). The upper frequency range (750-862 MHz) is used for downlink datastream communication between the processing devices. The lower frequency range (47-700 MHz) includes both the television channels and the downlink datastream channels for Internet access. The frequency splitters at the amplifier point on the one hand split the frequency spectrum between the uplink datastream, (Euro)DOCSIS and the downlink datastream, and additionally split the downlink spectrum into uplink and downlink channels for passing the signals back to the output point. In the DOCSIS segments, the frequencies for the downlink datastream and the uplink datastream are in each case determined by the processing device 60 and may be identical for each segment, because they are not passed on to the next segment.

The required amplifiers for the uplink (750-862 MHz) cost considerably less than the A amplifiers for the entire band, because: (i) this is a sub-octave band and there is no need to be concerned about problems with second order distortion, (ii) no push-pull amplifier is required, (iii) they can be tuned more easily, and (iv) the choice of the components is considerably less critical.

Of the 45 free channels in the frequency spectrum from 500 to 862 MHz, 10 channels are still kept free for the transmission of additional digital television programs. The remaining 35 channels are allocated to the respective processing device 60 for transportation of the downlink datastream and of the uplink datastream. This results in a total capacity in the coaxial network of about 1 Gbit/s without any separate glass-fiber connection. When using the existing copper cable, this represents a considerable saving rather than replacing it by glass fiber.

There are a number of possible ways to use the processing device 60 when the cable network is upgraded. A relatively low-cost method can be offered by the processing device 60 and by embodiments derived from it with a smaller range of functionalities (see the description in the following text relating to FIGS. 10 to 12), which allow even relatively small customer groups to use the digital services of the cable operators.

In the course of network and capacity planning, the DOCSIS segments are expediently designed such that the maximum capacity that is available is made use of. The DOCSIS channels are combined in the processing device 60, are concentrated in a channel in the upper frequency spectrum, and are passed to the output point, specifically to the feed point or to the handover point to the user interface. The monitoring of both the DOCSIS downlink datastreams and the uplink datastream is carried out by the processing device 60. Inputting of the DOCSIS signals at the B level in the amplifier points makes it possible to continue to use the frequencies that are used for the C levels in each segment, since they are not passed on to the next segment. The signals which have been gathered from all of the amplifier points are emitted at the output point to a telecommunications infrastructure.

When segments are connected in series, a bandwidth of about 600-700 Kbit/s is available in the last clusters—comparable with a DSL connection (calculated using a simultaneity factor of 1:6).

The frequencies which are used by the user modems in the respective segments of the television data cable network are loaded into the processing device 60 by a DOCSIS management server in the BBK or ÜBK. The processing device 60 assigns the configuration data to the respective modems in the segment, and manages the communication from the modems to the data network. Shifting the MAC/PHY layer from the CMTS to the processing device 60 results in the various embodiments of the processing device 60 becoming the management unit for the DOCSIS modem, rather than the CMTS as in the case of HFC technology. In consequence, all of the processing devices 60 in the cable network are independent nodes which can take part in the communication and outputting independently of the control center and the CMTS. Only the central management of the frequency tables still has to be carried out in the management server.

One of the main differences between a glass-fiber node and the processing device is, in particular, the fact that the processing device processes the data and modulates it again. This processing is necessary in order to achieve the desired efficiency in handling of the available resources. The uplink datastream at the respective amplifier points is concentrated in a 38 or 52 Mbit/s channel (approximately 4:1) and is passed to the output point in the upper frequency band. The additional concentration results in a communication delay, which could possibly result in the permissible “round-trip time” from the (Euro)DOCSIS Standard not being complied with. Since this time response would result in the customer modems no longer communicating with the CMTS, the MAC layer and the PHY layer of the CMTS are integrated in the processing device. In addition to complying with the (Euro)DOCSIS Standard, this has the advantage that the link between the segments can now also be provided by a purely digital link in each case. If required, by way of example, one segment could be provided via a 1 Gbit/s link from the _{Arcor} since the BlueGate acts as a bridge between the tele-communications network and the cable network. As before, the management server functions can remain in the CMTS in order to allow the processing device 60 and the HFC system to be combined.

If it is intended to increase the capacity in a 450 MHz segment, this can be achieved by a specific replacement of the A amplifiers and of the frequency splitters. The remote feed splitters for the return-channel are already available in the amplifier points, and are used only for inputting DOCSIS signals.

The investment required to upgrade existing cable networks is minimal with this procedure. The described embodiment requires one processing device per segment, as well as an additional amplifier for the return path via the upper frequency spectrum. The required capacity per segment is the governing factor for definition of the point or points at which the processing device or devices is or are included in the cable network.

Upgrading to A Level 862 MHz Technology

The difference from the 450 MHz network is the available downlink datastream capacity. If the A amplifiers are upgraded to 862 MHz, then the frequency spectrum from about 500 MHz up to 862 MHz is available for the downlink/uplink channels for communication from the processing device to the output point. This allows more user interfaces, (dwelling units) to be connected to the cable network before having to be output to a telecommunications network. Although the total number of possible user interfaces in the segment is increased, there is no need to upgrade the B and C amplifiers since the bandwidth per individual segment remains the same. This procedure is generally worthwhile for relatively large networks, since up to 20 A amplifiers can be connected in series.

Upgrading on the Basis of 450 MHz Technology with Interconnect Technology

Depending on the available telecommunications infrastructure from the cable network operator, it is possible, if required, to make use of outputting to third-party telecommunications lines before the signals are passed back to the broadband cable. From the financial point of view, this procedure may be more worthwhile than, for example, laying glass fibers. The BlueGate is for this purpose connected to the telecommunications infrastructure only at the desired output point. The concentrated data in the downlink datastream and uplink datastream is emitted to an interface which is connected to the backbone in the upper frequency range of the network. This cable network is connected to an ISP (ISP—“Internet Service Provider”). This procedure allows relatively small segments in a cable network to be upgraded very economically. If the required data volume increases subsequently, this segment can be coupled to its own infrastructure again, without any additional costs.

Capability for Combination with Conventional HFC Technology

The described method can be combined with existing HFC technology without any problems. This makes it possible to use HFC technology for urban network planning, where the “Rights of Way” exist for laying glass fibers. Additional glass fibers which will not be used immediately are frequently laid for cable operator network planning. These glass fibers can be used as a coupling for segments in which the described method can be carried out with the aid of one or more processing devices 60.

In order to implement bidirectional data transmission, amplifier points are provided in the segmented cable network in accordance with the individual requirements at the respective amplifier point. Simplified variants are used in addition to the use of the processing device 60. FIGS. 10, 11 and 12 show processing devices in detail which provide the full functionality of the processing device 60 (see FIG. 12) or only a part of it (see FIGS. 10 and 11). The following abbreviations are used in FIGS. 10 to 12: FSpW2—new remote feed with 3 frequency bands, FSpWR—remote feed splitter with return path, RüVr—return path amplifier, A/Vr—A line amplifier, MP—measurement point, HBVr—highband amplifier, CVt—C line distributor.

In the embodiment shown in FIG. 10, only the return path is combined and amplified in the conventional frequency range from 5 to 28.75 MHz. In this case, it should be noted that conventional C amplifiers do not have a suitable frequency splitter. This must therefore be introduced as an additional assembly in each case. The return paths of the C lines are emitted via new frequency splitters, and are combined with the return path signals from the following A line and the B lines. After amplification and frequency response correction, the combined return-path signal is fed into the return path of the preceding A line via the remote feed splitter (FSpWR). The functionality of the amplifier points in the embodiment shown in FIG. 10 corresponds to that of the amplifier points 83 in FIG. 9.

In the embodiment shown in FIG. 11, the signals in the highband (>470 MHz) are also amplified in both directions, in addition to the embodiment shown in FIG. 10. There is no need for any further processing of these signals. A new remote feed splitter with an additional range is required (FSpw2) in order to cover the upper frequency range. The same return amplifiers (RüVr) can be used for combination of the return-path signals in the frequency range from 5 to 28.75 MHz as those in the embodiment shown in FIG. 10. In addition, a bidirectional highband amplifier (HBVr) is required, whose directions are separated via appropriate frequency splitters. Equalizers and attenuators must be provided for matching to the cable connections of the incoming and outgoing A lines. The functionality of the amplifier points in the embodiment shown in FIG. 11 corresponds to that of the amplifier points 84 in FIG. 9.

The embodiment of the extended amplifier point shown in FIG. 12 represents the central node for a segment to be supplied in the cable network. In particular, this embodiment also provides the basic functionality of a DOCSIS-CMTS. The return-path signals are once again collected in the RüVr assembly, but are not then passed to the incoming A line and, instead, are supplied to a group of DOCSIS uplink datastream receivers (DOCSIS demodulation). Since both the incoming A line and the outgoing A line carry highband signals as a component of the backbone, extended remote feed splitters (FSpw2) must be used, which are known from the embodiment shown in FIG. 11, must be used for connection. The connection for the 5 to 28.75 MHz return path to the remote feed splitter (FSpw2) for the incoming A line is unused in this embodiment (terminating impedance). The DOCSIS uplink data is multiplexed by the control processor onto the highband uplink datastream. For this purpose, all of the highband uplink datastream channels are output via frequency splitters, and are demodulated in a group of DVB demodulators. The newly multiplexed datastreams are supplied to a group of DVB modulators, whose output signals are amplified and are fed via frequency splitters into the incoming A line. A group of further DVB demodulators receives the data intended for the segment to be supplied in the cable network, and this data is converted by a group of DOCSIS transmitters (DOCSIS modulation) to the frequency range from 47 to 450 MHz that is intended for distribution. These channels are combined with the pure distribution signals by means of a special combining assembly (Comb).

The embodiments illustrated in FIGS. 10 to 12 have been based on the assumption that the backbone in the upper frequency range extends only over one A line of the cable network. However, without any restrictions, the backbone can also be extended to B lines, and single branches are also possible. The block diagrams of the extensions of an amplifier point on a B line then differ from those of the types considered so far in FIGS. 11 and 12 in that the A/BVr operates on a B line, and the BVr together with the associated remote feed splitters (FSpWR) is omitted (see FIG. 13). Branches are possible both in the embodiment shown in FIG. 11 and in the embodiment shown in FIG. 12. The previously unused coupler in the highband amplifier is used for this purpose. FIG. 13 illustrates this for an embodiment which is similar to the embodiment shown in FIG. 11. In this example, the highband from the outgoing A line is combined with the highband on one of the two outgoing B lines via the coupler. A new frequency splitter (FSpW2) is likewise required on the relevant B line for this purpose. No provision is made for multiple branches from the backbone from an amplifier point (Vrp) owing to the high coupler attenuation associated with this.

The described exemplary embodiments have been described with reference to the DOCSIS Standard. However, the advantages of the invention are also achieved in conjunction with other normal standards for electronic data transmission, in particular the IEEE 802.3 Standard and the IEEE 802.11 Standard.

The features of the invention which have been disclosed in the above description, in the claims and in the drawing may be significant both individually and in any desired combination for implementation of the various embodiments of the invention.

1. A method for bidirectional transmission of electronic data in a television data cable network having segments which each comprise two or more user interfaces, with each of the segments being connected via a cable connection to a feed point for the television data cable network, and with the method comprising the following steps:
a) downlink transmission of electronic data from the feed point to at least some of the user interfaces of one or of all of the segments via the cable connection, in which
requested electronic data is fed into the cable connection as digital downlink data via the feed point and is transmitted from the feed point to a processing device which is connected downstream from the feed point in the cable connection, of a first type;
from the digital downlink data in the processing device of the first type, local electronic data is produced for distribution to at least one user interface in a local segment which is coupled to the processing device of the first type, and electronic downlink remote data is produced for transmission in a downlink radio-frequency band in an upper cut-off area of a transmission bandwidth of the cable connection;
the local electronic data is transmitted in a downlink frequency band within the transmission bandwidth of the cable connection, which is formed below the downlink radio-frequency band;
the electronic downlink remote data is fed into the downlink radio-frequency band of the cable connection by means of the processing device of the first type, and is transmitted via the cable connection to a further processing device of the first type; and
the electronic downlink remote data is converted in the further processing device of the first type to further local electronic data for distribution to at least one user interface in a further local segment which is coupled to the further processing device of the first type;
b) uplink transmission of electronic data from at least one of the user interfaces of one or all of the segments to the feed point via the cable connection, in which
electronically recorded user data is fed into the cable connection via the at least one user interface;
electronic uplink remote data is produced from the electronically recorded user data in the further processing device of the first type, which is connected upstream of the at least one user interface in the cable connection;
the electronic uplink remote data is fed into an uplink radio-frequency band in the upper cut-off area of the transmission bandwidth of the cable connection by means of the further processing device of the first type, and is transmitted via the cable connection to the processing device of the first type; and
the electronic uplink remote data is converted in the processing device of the first type to digital uplink data, and is transmitted via the cable connection to the feed point.

2. The method as claimed in claim 1, characterized in that the downlink radio-frequency band and the uplink radio-frequency band are adjacent frequency bands.

3. The method as claimed in claim 1, characterized in that the upper cut-off frequency of the transmission bandwidth of the cable connection is used as the upper cut-off frequency for the uplink radio-frequency band.

4. The method as claimed in claim 1, characterized in that the downlink radio-frequency band and the uplink radio-frequency band are formed above a frequency of about 470 MHz.

5. The method as claimed in claim 1, characterized in that the local electronic data is transmitted to the at least one user interface in the local segment, and the further local electronic data is transmitted to the at least one user interface in the further local segment in accordance with a DOCSIS Standard (DOCSIS—“Data Over Cable Service Interface Specification”), the IEEE 802.3 or the IEEE 802.11.

6. The method as claimed in claim 1, characterized in that a cable modem or an adaptor device is in each case used in the user interface.

7. The method as claimed in claim 1, characterized in that the electronic downlink remote data is amplified during the transmission in the downlink radio-frequency band of the cable connection between the processing device of the first type and the further processing device of the first type, and/or the electronic uplink remote data is amplified during the transmission in the uplink radio-frequency band of the cable connection between the further processing device of the first type and the processing device of the first type, by means of a processing device of a second type, which is connected between the processing device of the first type and the further processing device of the first type, with the processing device of the second type also transmitting the local electronic data and/or the further electronic data in the downlink and uplink directions.

8. An apparatus for use for a method for bidirectional transmission of electronic data in a television data cable network having segments which each comprise two or more user interfaces, with each of the segments being connected via a cable connection to a feed point for the television data cable network, having:
b1) a processing module for processing digital uplink data having:
output means for outputting digital downlink data from the cable connection, which is fed into the cable connection via a feed point;
receiving means for reception of the output, digital downlink data from the output means;
demodulation means, which are connected downstream from the receiving means, for demodulation of the output, digital downlink data;
a central control device, which has production means for production of electronic downlink remote data from the demodulator, output, digital downlink data for transmission in a downlink radio-frequency band in an upper cut-off area of a transmission bandwidth of the cable connection;
modulation means for modulation of the electronic downlink remote data for the downlink radio-frequency band; and
input means for inputting the modulated electronic downlink remote data into the downlink radio-frequency band of the cable connection; and
b2) a further processing module for processing electronically recorded user data, having:
further output means for outputting electronically recorded user data from the cable connection, which is fed via at least one user interface into the cable connection;
further receiving for reception of the output, electronically recorded user data from the further output means;
further demodulation means, which are connected downstream from the further receiving means, for demodulation of the output and the received electronically recorded user data;
further production means, which are formed by the central control device, for production of electronic uplink remote data from the demodulated, output, electronically recorded user data for transmission in an uplink radio-frequency band in the upper cut-off area of the transmission bandwidth of the cable connection;
further modulation means for modulation of the electronic uplink remote data for the uplink radio-frequency band; and
further input means for inputting the modulated electronic uplink remote data into the uplink radiofrequency band for the cable connection.

9. The apparatus as claimed in claim 8, characterized by an interface device which is coupled to the central control device for transmission of local electronic data, which is produced with the aid of the central control device, in a downlink frequency band of the transmission bandwidth of the cable connection, which is formed below the downlink radio-frequency band.

10. The apparatus as claimed in claim 8, characterized by a radio interface device, which is coupled to the central control device, for transmission of local electronic data, which is produced with the aid of the central control device, via a radio link.

11. The apparatus as claimed in claim 8, characterized by amplifi-cation means for amplification of the electronic downlink remote data for the downlink radio-frequency band, and/or of the electronic uplink remote data for the uplink radio-frequency band.
